(19) United States
(12) Patent Application Publication
(10) Pub. No.: US 2002/0090415 A1
(43) Pub. Date: Jul. 11, 2002

(54) Apparatus for injection-molding plastic material articles

(76) Inventor: Richard Herbst, Kranzberg (DE)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/883,689

(22) Filed: Jun. 17, 2001

(30) Foreign Application Priority Data
Jun. 19, 2000 (DE) 100 29 154.6

(51) Int. Cl. B29C 45/40

(52) U.S. Cl. 425/556; 425/444

(57) ABSTRACT

An apparatus for injection-molding plastic material articles comprises a mold having a plurality of mold portions. The mold portions are adapted to be displaced relative to one another along a first, horizontally extending axis between an open position and a closed position of the mold, An arm of a handling system is provided for unloading the plastic material articles from cavities in one of the mold portions. The arm is adapted to be advanced between the mold portions in the open position of the mold within a guide along a second, likewise horizontal axis extending essentially under right angles relative to the first axis The guide extends in the area of a lower side of the arm.

### BACKGROUND OF THE INVENTION

An apparatus of the afore-mentioned kind is disclosed in document DE 198 48 419 C1.

In injection molding machines of the type specified above, the handling arm essentially configurates a vertical plane extending transversely relative to the mold longitudinal axis. The handling arm is supported within a guide or guide rail, respectively, being located above the handling arm and, hence, above the mold. Therefore, the handling arm hangs downwardly from that guide rail and may be displaced along the rail. This configuration is chosen in conventional plastic material injection molding machines generally because the plastic material articles that are still located on the handling arm shall be conveyed away after the handling arm has been removed from the mold. A conveyor of the like is normally used for that purpose and the conveyor is located below the handling arm. Therefore, it is reasonable to pick the plastic material articles from the handling arm in a downward direction and to transfer same on the conveyor.

However, in certain applications this conventional design of a plastic material injection molding machine or the handling system, respectively, utilized therewith, has specific disadvantages. Insofar, the production of plastic material articles under clean room conditions should be mentioned. For, in the pharmaceutical and the medical instrument industry, plastic material injection molding machines are used for manufacturing plastic material articles which, later on, shall be used under clinical circumstances, in particular within medical laboratories. Such articles are, for example, pipettes, petri dishes or like articles as are conventionally used for medical and laboratory purposes. During the production of such articles, it is normally intended to create an aseptic environment already at the moment in time of production so that the articles after their production within the plastic material injection molding machine their unloading from that machine and their, conveying away need not to be sterilized again or at least not that thoroughly sterilized.

In clean rooms of the kind of interest in the present context, a so-called laminar flow is conventionally set. The term “laminar flow” is understood to mean a highly homogeneous air flow directed vertically from the ceiling to the floor of a room. In a clean room, highly cleaned air is fed to the room via corresponding elements within the ceiling, and the air removed at the floor of the room subsequently undergoes a cleaning process. The reason for doing so is to immediately remove any particles that may be present or generated within the clean room so that there is no contamination of the objects handled within the clean room.

Within a handling system for applications in connection with plastic material injection molding machines, there exists a problem insofar that a handling arm that is displaced along an axis within a guide unavoidably generates contaminant particles. These particles are mostly generated in the area of the guide, in particular in the area of the guide elements therein. The particles are essentially generated through the wear of the acting guide elements or by vaporization of lubricants or the like.

If now an apparatus or a handling system, respectively, of conventional design is utilized in such a clean room atmosphere with a laminar flow, then the particles generated in the area of the guide will be transported towards the floor of the room by means of the air flow and will be removed there, however, on their way down to the floor they may get in touch with the manufactured plastic material articles and may contaminate same.

It is therefore, an object underlying the invention to improve an apparatus of the type specified at the outset such that these disadvantages are avoided. In particular, the invention shall provide an apparatus that may be used under clean room conditions.

### SUMMARY OF THE INVENTION

In an apparatus of the type specified at the outset, this object is achieved according to the present invention in that the guide extends in the area of a lower side of the arm.

The object underlying the invention is thus entirely solved.

The invention teaches away from conventional concepts of prior art apparatuses in which the guide for the arm of the handling system is located at the upper side of the arm. Instead, the location at which the contaminant particles may be generated is transferred to the lower side of the apparatus and, hence, into an area below the plane within which the plastic material articles are conventionally handled. If the apparatus is then utilized within a clean room with a laminar flow established therein, the particles generated in the area of the guide will immediately be taken away in the direction towards the floor so that their trajectory does not interfere with the trajectory of the plastic material articles A contamination may, hence, be practically excluded.

In a preferred embodiment of the inventive apparatus the guide is located below the mold portions.

This measure has the advantage that a particularly simple design of the apparatus becomes possible because the trajectories of the mold portions and of the guide do not intersect.

In a further modification of the invention, a second axis extends essentially in the area of a guide and the arm is adapted to be pivoted about the second axis between an essentially vertical position and an essentially horizontal position.

This measure has the advantage that a particularly simple conveying away of the plastic material articles becomes possible in that the arm is adapted to be pivoted by itself so that the plastic material articles, for example, need only to simply fall from the arm onto a conveyor belt.

This holds true in particular when the plastic material articles are transferred from the arm onto a conveyor in a horizontal position of the arm.

Insofar, it is further preferred when the conveyor extends above the second axis. In that situation, it may, namely, be assured, as already mentioned, that in an application in connection with a clean room the particles that are generated in the area of the guide are taken away by the laminar flow with no intersection between the trajectory of the particles and the conveyor path of the articles.

As has already been mentioned repeatedly, the apparatus may advantageously be used in a clean room with a vertically and downwardly directed laminar flow therein. However, this is not to be understood as a limitation.

Further advantages will become apparent from the description and the enclosed drawing.

It goes without saying that the features mentioned before and those that will be explained hereinafter, may not only be used in the particularly given combination but also in other combinations or alone without leaving the scope of the present invention.

### BRIEF DESCRIPTION OF THE DRAWINGS

An embodiment of the invention is shown in the drawing and will he explained in further detail in the subsequent description.

FIG. 1 shows a highly schematic side elevational view of an embodiment of an apparatus according to the present invention;

FIG. 2 is a top plan view on the apparatus of FIG. 1.

### DETAILED DESCRIPTION OF THE PREFERRED EMBODIMENTS

In the drawing, reference numeral 10 as a whole indicates a plastic material injection molding machine of essentially conventional design. Machine 10 comprises a first mold portion 12 and a second mold portion 14. Cavities 16 are indicated within first mold portion 12.

Mold portions 12 and 14 are adapted to be displaced relative to one another along a first, horizontally extending axis 18 in the direction of a double arrow 19. Insofar, one mold portion is conventionally made stationary and the other mold portion adapted to be displaced. Within the scope of the present invention, however, also other configurations of molds may be utilized, for example so-called “stack molds” comprising three or more mold portions which are displaced relative to one another.

Reference numeral 20 as a whole indicates a handling system. Handling system 20 comprises an arm 22, Arm 22 extends essentially in a vertical plane. As a consequence, it has an upper side 22a and a lower side 22b.

Arm 22 is adapted to be displaced along a second, likewise horizontal axis 24. Second axis 24 extends essentially under right angles relative to first axis 18. In a practical embodiment, second axis 24 is configurated by a guide 26, for example a guide rail. Arm 22 may be displaced along that guide 26 in the direction of a double arrow 28 in FIG. 2. Guide 26 or the guide rail are dimensioned so long that arm 24 in the open position of mold portions 12, 14 may enter between same, whereas in the closed position of mold portions 12, 14 it may be retracted and positioned outside mold portions 12 and 14. This may particularly be seen in FIG. 2.

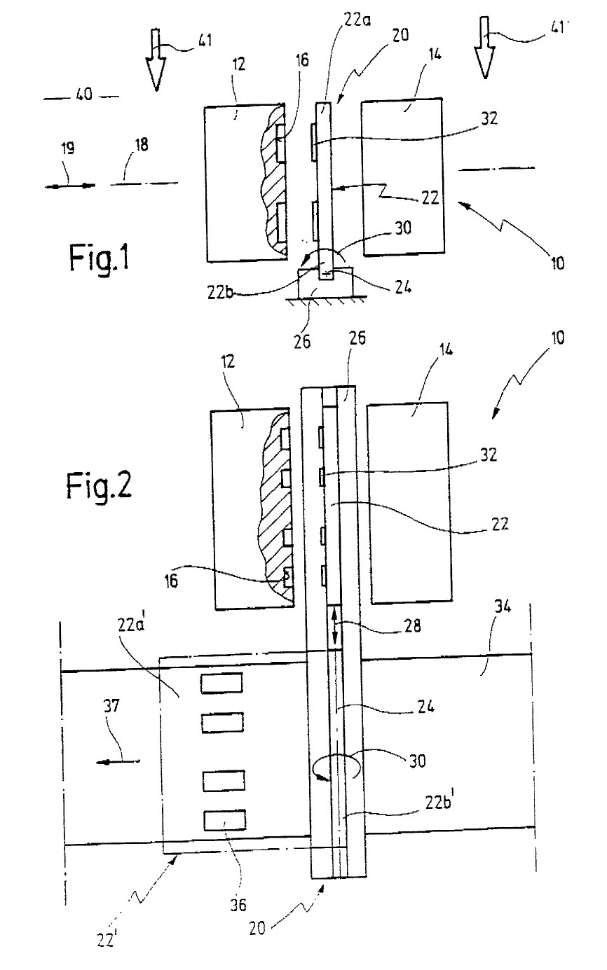

At least in the area outside the trajectory of mold portions 12 and 14, guide 26 in the area of second arm 24 is configurated so that arm 22, additionally, may be pivoted about second axis 24, as indicated by an arrow 30 in FIGS. 1 and 2.

Arm 22 has a plurality of seats 32, for example suction heads or the like, enabling to unload plastic material articles from cavities 16.

A conveyor or conveyor belt 34 extends laterally from mold portions 12, 14 and preferably above second axis 24. Plastic material articles 36 may be picked up by conveyor belt 34 and may be carried away as indicated by an arrow 27.

The afore-described apparatus is preferably used within clean rooms. The clean room is indicated in FIG. 1 by reference numeral 40. Within clean rooms, a so-called laminar flow 41 is established, i.e. a homogeneous flow of air flowing in a vertical direction from a ceiling to a floor of clean room 40. Clean rooms of the type of interest in the present context are generally known and need not to be explained in further detail here.

The operation of the apparatus shown in FIGS. 1 and 2 is as follows:

Within plastic material injection molding machine 10, plastic material articles 36 are produced in a conventional manner. After termination of the injection process, mold portions 12 and 14 move away from each other and arm 22 enters into the gap between mold portions 12 and 14. This is the operational position of arm 20 shown in solid lines in FIGS. 1 and 2.

By means of seats 32, plastic material articles 36 are now unloaded from hollow cavities 16 of first mold portion 12 Arm 22, extending vertically, is now displaced in an outward direction along second axis 24, i.e. along guide 26, until it is outside the trajectory of mold portions 12 and 14 and is now essentially above conveyor belt 34. During that period of time, a upper side 22a of arm 22 is above and lower side 22b is in the area of second axis 24 or guide 26, respectively.

After having assumed the second operational position, arm 22 is now pivoted about second axis 24, namely about approximately 90°, so that it comes into a position 22′ shown in FIG. 2 in dash-dot lines. In that second operational position, upper side 22 is essentially at the same altitude as lower side 22b. Arm 22, hence, is oriented essentially parallel above conveyor belt 34 so that plastic, material articles 36 after releasing the pick up force within seats 32 will fall onto conveyor belt 34 under the action of gravity and may then be carried away (arrow 37).

It is important in this context that guide 26 of arm 22 is located in the area of lower side 22b, in any event below hollow cavities 16 and seats 32 in the first operational position of arm 22. Particles that may be generated in the area of guide 26 will then be carried away by laminar flow 41 in a downward direction and will be disposed via the floor of clean room 40.

Guide 26 is preferably located below conveyor belt 34 so that the afore-mentioned particles may also not come into the area of conveyor belt 34.

Seen as a whole, it is not to be expected that particles generated within guide 26 may contaminate plastic material articles 36 because their trajectory (being taken along by laminar flow 41) does not intersect the trajectory of plastic material articles 36.

1. An apparatus for injection-molding plastic material articles comprising a mold having a plurality of mold portions, said mold portions being adapted to be displaced relative to one another along a first, horizontally extending axis between an open position and a closed position of said mold, and an arm of a handling system for unloading said plastic material articles from cavities in one of said mold portions, said arm being adapted to be advanced between said mold portions in said open position of said mold within guide means along a second, likewise horizontal axis extending essentially under right angles relative to said first axis, said guide means extending essentially on a lower side of said arm.

2. The apparatus of claim 1, wherein said guide means is located below said mold portions.

3. The apparatus of claim 1, wherein said second axis extends essentially near said guide means, said arm being adapted to be pivoted about said second axis between an essentially vertical position and an essentially horizontal position.

4. The apparatus of claim 3, wherein said plastic material articles are adapted to be transferred from said arm to a conveyor when said arm is in said horizontal position.

5. The apparatus of claim 4, wherein said conveyor extends above said second axis.

6. A clean room in which a laminar flow flows downwardly in a vertical direction and an apparatus for injection-molding plastic material articles arranged therein, said apparatus comprising a mold having a plurality of mold portions, said mold portions being adapted to be displaced relative to one another along a first, horizontally extending axis between an open position and a closed position of said mold, and an arm of a handling system for unloading said plastic material articles from cavities in one of said mold portions, said arm being adapted to be advanced between said mold portions in said open position of said mold within guide means along a second, likewise horizontal axis extending essentially under right angles relative to said first axis, said guide means extending essentially on a lower side of said arm downstream said laminar flow.
